(19) United States
(12) Patent Application Publication
(10) Pub. No.: US 2018/0320067 A1
(43) Pub. Date: Nov. 8, 2018

(54) METHOD FOR PREPARING GRAPHENE/MnO2 POROUS MATERIAL HAVING HIGH INFRARED EMISSIVITY

(71) Applicants: Aie Ding, Road Town (VG); Guohua Chen, Road Town (VG); Yihong Zhang, Road Town (VG)

(72) Inventors: Aie Ding, Road Town (VG); Guohua Chen, Road Town (VG); Yihong Zhang, Road Town (VG)

(21) Appl. No.: 15/666,124

(22) Filed: Aug. 1, 2017

(30) Foreign Application Priority Data
May 8, 2017 (CN) 201710315836.4

(51) Int. Cl. C09K 11/65

(52) U.S. Cl. CPC C09K 11/65

(57) ABSTRACT

A method for preparing a graphene/MnO₂ porous material having a high infrared emissivity; the method adopts graphene and potassium permanganate as raw materials, and uses a simple ultrasonic dispersion method to uniformly disperse the graphene and the potassium permanganate in the water solution; subsequently, the graphene/MnO₂ porous material can be obtained through the hydrothermal reaction; the present invention is simple and easy-operating, and the infrared emissivity of the porous material prepared according to the method of the present invention is 0.94-0.98 at a distance of 8-14 μm, which is stable, eco-friendly, and can be widely applied to far-infrared products.

### TECHNICAL FIELD OF THE INVENTION

The present invention relates to the technical field of manufacturing functional materials, and more particularly, to a method for preparing a graphene/MnO₂ porous material having a high infrared emissivity.

### BACKGROUND OF THE INVENTION

Sunlight can be roughly divided into visible light and invisible light. The visible light can reflect purple, blue, green, yellow, orange and red light when passing through a triple prism. The light having a wavelength within the range of 0.75-1000 μm in the spectrum is called infrared light or infrared ray, which is an electromagnetic wave having a strong heat. Infrared light has longer wavelengths than visible light, and is therefore invisible. People usually divide the different ranges of infrared light into near-infrared area, intermediate-infrared area and far-infrared area; and, the electromagnetic waves having corresponding wavelengths are respectively called as near-infrared light, intermediate-infrared light and far-infrared light. The far-infrared light is normally defined as an electromagnetic wave having a wavelength within the range of 5.6-1000 μm.

When the temperature of an object exceeds absolute zero, its electrons start to vibrate. The vibration of these electrons becomes stronger when the temperature of the object rises, thereby enabling the particles to collide with each other. Consequently, the outer electrons are able to escape their original orbits to reach positions having a higher energy. However, these electrons cannot stably remain at the new positions, which can jump back to the original ones at anytime, namely, jumping back from the unstable positions having a higher energy to those having a lower energy. Every time an electron jumps back, quantum energy is generated to release a radiant energy. For materials having a high infrared emissivity, the radiant energy output is an infrared ray.

Far-infrared radiation can be widely applied in various fields such as food preservation, cardiovascular system protection and health care. Some studies show that the far-infrared ray possesses potential and positive effects on wound healing, tumor thermotherapy, and treatments of diabetes, chronic fatigue syndrome and knee arthritis. Far-infrared emitting materials are capable of converting the energy absorbed from the sunlight and the body heat into a far-infrared ray having a wavelength within a specific range, which can be re-emitted to human bodies. A human body is not merely a radiation source of far-infrared ray, but can absorb far-infrared radiation. The range of the far-infrared ray having a wavelength of 8-14 μm is basically the same as that of the body radiation. After being absorbed by a human body, it can strongly vibrate and rotate at a molecular level. Consequently, blood vessels can be dilated, thereby enhancing the blood microcirculation and metabolism to produce a series of beneficial effects to human bodies.

In recent years, materials having a far-infrared function and the related products have been universally welcomed by consumers, showing an enormous growth potential. With the development of living standards, people increasingly prioritize their physical conditions. Thus, the development of materials having infrared emitting ability has a bright market prospect and significant application value.

Since graphene was discovered, it has attracted much attention due to its excellent properties, including prominent mechanical property, ultra-high electron mobility, perfect heat-conducting performance, and ultra-large specific surface area, etc. Consequently, graphene and its derivatives have been widely applied in biomedical fields such as biological components, disease diagnosis and cancer therapies, etc. Additionally, graphene material possesses many excellent optical properties, which can absorb and radiate even 40% of far-infrared ray. Many far-infrared health products relating to graphene have been recently developed, such as graphene far-infrared therapy clothes, graphene far-infrared waist-protecting belts, and modified graphene far-infrared emitting cotton fabrics. Although testing results show that the far-infrared emissivity of the modified graphene cotton fabrics has been greatly improved, reaching 0.911 after being processed for three times, its emissivity is still not high enough. Thus, it's significant to develop a graphene material having a higher infrared emissivity.

In the prior art, the graphene/MnO₂ composite material is mainly used as an electrode material, and researchers always focus on its electrochemical performance. The far-infrared performance of the graphene/MnO₂ composite material has not been reported.

### SUMMARY OF THE INVENTION

The purpose of the present invention is to provide a method for preparing a graphene/MnO₂ porous material having a high infrared emissivity, which uses graphene and potassium permanganate as raw materials to prepare the porous material through the simple ultrasonic dispersion method and hydrothermal method. The present invention is simple and easy-operating, and the porous material prepared according to the method of the present invention has a high infrared emissivity. It is stable and eco-friendly, and can be widely applied to far-infrared products.

To achieve the above purpose, the present invention adopts the following technical solution:

A method for preparing a graphene/MnO₂ porous material having a high infrared emissivity, comprising the steps of:

Step 1: dissolving the graphene powder in distilled water; subsequently, dispersing it via the ultrasonic dispersion method for 40 minutes, thereby enabling the graphene to be entirely dispersed;

Step 2: adding potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace for a hydrothermal reaction;

Step 4: obtaining the powder of the graphene/MnO₂ porous material having a high infrared emissivity after extracting, filtering, washing and drying.

In another aspect of the present invention, the graphene is prepared via the mechanical stripping method.

In another aspect of the present invention, the mass ratio of the potassium permanganate added in step 2 and the graphene added in step 1 is 4:1-90:1.

In another aspect of the present invention, the temperature of the hydrothermal reaction is 150-180° C., and the reaction time is 6-8 hours.

In another aspect of the present invention, the concentration of the potassium permanganate in the solution during the hydrothermal reaction is 0.05-0.4 mol/L.

The graphene/MnO₂ porous material having a high infrared emissivity of the present invention is a lamellar porous structure similar to foamed nickel, of which the average pore size is 60 nm and the far-infrared emissivity at a distance of 8-14 μm can reach 0.94-0.98.

Compared with the prior art, the present invention has the following advantages:

It adopts graphene and potassium permanganate as raw materials to prepare the porous material through the simple ultrasonic dispersion method and hydrothermal method. It is simple and easy-operating, the raw materials can be easily obtained, and the porous material prepared via the method of the present invention has a high far-infrared emissivity. The present invention is stable and eco-friendly, which is suitable for industrial productions, and can be widely applied to various far-infrared products.

### BRIEF DESCRIPTION OF THE DRAWINGS

To clearly expound the present invention or technical solution, the drawings and embodiments are hereinafter combined to illustrate the present invention. Obviously, the drawings are merely some embodiments of the present invention and those skilled in the art can associate themselves with other drawings without paying creative labor.

FIG. 1 is a SEM image of the graphene/MnO₂ porous material having a high infrared emissivity prepared via the method of the present invention.

### DETAILED DESCRIPTION OF THE INVENTION

Drawings and detailed embodiments are combined hereinafter to elaborate the technical principles of the present invention.

### Embodiment 1

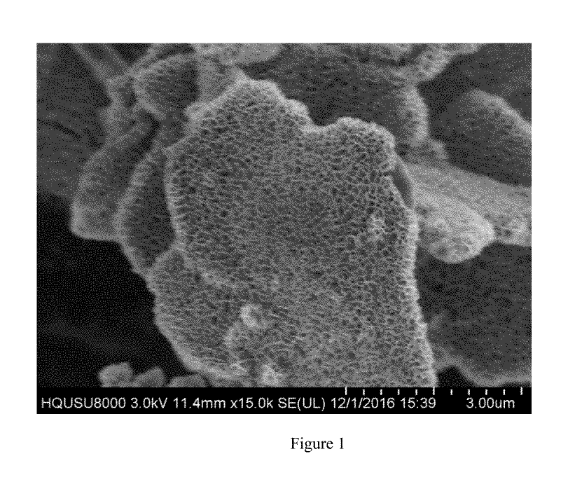

As shown in FIG. 1, the present invention provides a method for preparing the graphene/MnO₂ porous material having a high infrared emissivity, which comprises the steps of:

Step 1: placing 0.2 g graphene powder prepared via the mechanical stripping method into a beaker; subsequently, adding 100 ml distilled water and dispersing via the ultrasonic dispersion method for 40 minutes, thereby enabling the graphene to be entirely dispersed;

Step 2: adding 1.4542 g potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace to hydrothermally react for 6 hours at a temperature of 150° C.;

Step 4: obtaining the powder of the graphene/MnO₂ porous material having high infrared emissivity after extracting, filtering, using distilled water to wash for several times, and drying in the drying oven.

FIG. 1 is a microstructure of the product prepared according to the method of embodiment 1, which is analyzed by a scanning electron microscope (SEM). It shows that the structure of the graphene/MnO₂ porous material having a high infrared emissivity of the present invention is a lamellar porous structure similar to foamed nickel, of which the average pore size is 60 nm and the far-infrared emissivity is 0.94.

### Embodiment 2

The present invention provides a method for preparing the graphene/MnO₂ porous material having a high infrared emissivity, which comprises the steps of:

Step 1: placing 0.2 g graphene powder prepared via the mechanical stripping method into a beaker; subsequently, adding 100 ml distilled water and dispersing via the ultrasonic dispersion method for 40 minutes, thereby enabling the graphene to be entirely dispersed;

Step 2: adding 3.2719 g potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace to hydrothermally react for 6 hours at a temperature of 150° C.;

Step 4: obtaining the powder of the graphene/MnO₂ porous material having a high infrared emissivity after extracting, filtering, using distilled water to wash for several times, and drying in the drying oven.

After being tested, the infrared emissivity of the product is 0.96.

### Embodiment 3

The present invention provides a method for preparing the graphene/MnO₂ porous material having high infrared emissivity, which comprises the steps of:

Step 1: placing 0.1 g graphene powder prepared via the mechanical stripping method into a beaker; subsequently, adding 100 ml distilled water and dispersing via the ultrasonic dispersion method for 40 minutes, thereby enabling the graphene to be entirely dispersed;

Step 2: adding 3.4537 g potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace to hydrothermally react for 6 hours at a temperature of 150° C. ;

Step 4: obtaining the powder of the graphene/MnO₂ porous material having a high infrared emissivity after extracting, filtering, using distilled water to wash for several times, and drying in the drying oven.

After being tested, the infrared emissivity of the product is 0.97.

### Embodiment 4

The present invention provides a method for preparing the graphene/MnO₂ porous material having high infrared emissivity, which comprises the steps of:

Step 1: placing 0.05 g graphene powder prepared via the mechanical stripping method into a beaker; subsequently, adding 100 ml distilled water and dispersing via the ultrasonic dispersion method for 40 minutes, thereby enabling the graphene to be entirely dispersed;

Step 2: adding 4.4889 g potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace to hydrothermally react for 8 hours at a temperature of 150° C. ;

Step 4: obtaining the powder of the graphene/MnO₂ porous material having a high infrared emissivity after extracting, filtering, using distilled water to wash for several times, and drying in the drying oven.

After being tested, the infrared emissivity of the product is 0.98.

### Embodiment 5

The present invention provides a method for preparing the graphene/MnO₂ porous material having high infrared emissivity, which comprises the steps of:

Step 1: placing 0.3 g graphene powder prepared via the mechanical stripping method into a beaker; subsequently, adding 100 ml distilled water and dispersing via the ultrasonic dispersion method for 40 minutes, thereby enabling the graphene to be entirely dispersed;

Step 2: adding 3.6721 g potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace to hydrothermally react for 7 hours at a temperature of 160° C.;

Step 4: obtaining the powder of the graphene/MnO₂ porous material having a high infrared emissivity after extracting, filtering, using distilled water to wash for several times, and drying in the drying oven.

After being tested, the infrared emissivity of the product is 0.96.

### Embodiment 6

The present invention provides a method for preparing the graphene/MnO₂ porous material having high infrared emissivity, which comprises the steps of:

Step 1: placing 0.2 g graphene powder prepared via the mechanical stripping method into a beaker; subsequently, adding 100 ml distilled water and dispersing via the ultrasonic dispersion method for 40 minutes, thereby enabling the graphene to be entirely dispersed;

Step 2: adding 3.8713 g potassium permanganate into the solution obtained from step 1; subsequently, continuously dispersing via the ultrasonic dispersion method for 30 minutes;

Step 3: transferring the mixed solution obtained from step 2 into a hydrothermal synthesis reactor; subsequently, placing the reactor into a box-shaped furnace to hydrothermally react for 6 hours at a temperature of 180° C. ;

Step 4: obtaining the powder of the graphene/MnO₂ porous material having a high infrared emissivity after extracting, filtering, using distilled water to wash for several times, and drying in the drying oven.

After being tested, the infrared emissivity of the product is 0.95.

The previous descriptions are of preferred examples for implementing the invention, and the scope of the invention should not necessarily be limited by this description. The scope of the present invention is defined by the claims.

1. A method for preparing a graphene/MnO₂ porous material having a high infrared emissivity, comprising the steps of:
Step 1: dissolving the graphene powder in distilled water; subsequently, dispersing via the ultrasonic dispersion method for 40 minutes, thereby enabling the graphene to be entirely dispersed;
Step 2: adding potassium permanganate into the solution obtained from step 1; subsequently, continuously dispersing via the ultrasonic dispersion method for 30 minutes;
Step 3: transferring the mixed solution obtained from step 2 into a hydrothermal synthesis reactor; subsequently, placing the reactor into a box-shaped furnace for a hydrothermal reaction;
Step 4: obtaining the powder of the graphene/MnO₂ porous material having a high infrared emissivity after extracting, filtering, washing and drying.

2. The method for preparing the graphene/MnO₂ porous material having a high infrared emissivity of claim 1, wherein the graphene is prepared via the mechanical stripping method.

3. The method for preparing the graphene/MnO₂ porous material having a high infrared emissivity of claim 1, wherein the mass ratio of the potassium permanganate added in step 2 and the graphene added in step 1 is 4:1-90:1.

4. The method for preparing the graphene/MnO₂ porous material having a high infrared emissivity of claim 1, wherein the temperature of the hydrothermal reaction is 150-180° C., and the reaction time is 6-8 hours.

5. The method for preparing the graphene/MnO₂ porous material having a high infrared emissivity of claim 1, wherein the concentration of the potassium permanganate in the solution during the hydrothermal reaction is 0.05-0.4 mol/L.
